(19) United States
(12) Patent Application Publication
(10) Pub. No.: US 2011/0116468 A1
(43) Pub. Date: May 19, 2011

(54) Handover of user equipment

(76) Inventor: Yuan Zhu, Beijing (CN)

(21) Appl. No.: 11/794,785

(22) PCT Filed: Jan. 4, 2005
(86) PCT No.: PCT/IB05/00003

§ 371 Date: Mar. 29, 2010

(51) Int. Cl. H04W 36/08

(52) U.S. Cl. 370/331

(57) ABSTRACT

The invention relates to supporting a handover of user equipment (12) from a source cell of a cellular communication network to a target cell of this network, wherein the user equipment employs assigned timeslots for a data exchange with the network while being associated to the source cell. In order to reduce sudden changes in interference due to the handover, it is checked for at least one of the assigned timeslots whether it is suited to meet given conditions when employed in the target cell for a data exchange between user equipment and the network (step 203). In case this at least one timeslot is suited to meet the given conditions, it is then assigned to the user equipment for use in the target cell (step 204).

### CROSS REFERENCE TO RELATED APPLICATIONS

This application is the U.S. National Stage of International Application Number PCT/IB05/000003 filed on Jan. 4, 2005 which was published in English on Jul. 13, 2006 under International Publication Number WO 2006/072811.

### FIELD OF THE INVENTION

The invention relates to a method for supporting a handover of user equipment from a source cell of a cellular communication network to a target cell of the mobile communication network, wherein the user equipment employs assigned timeslots for a data exchange with the cellular communication network while being associated to the source cell. The invention relates equally to a network element for a cellular communication network, to user equipment, to a cellular communication system, to a software code and to a software program product supporting such a handover.

### BACKGROUND OF THE INVENTION

The coverage area of a cellular communication network is divided into cells, each cell being served by another base transceiver station (BTS). User equipment located in the area of a particular cell can access the cellular communication network via the associated BTS. When moving, the user equipment may have to be handed over from one cell to another and thus from one BTS to another for maintaining an established connection to the network.

In a cellular communication system supporting transmissions between a cellular communication network and user equipment of multiple users, different multiple access technologies can be employed for sharing available radio resources. Such multiple access technologies include for instance time division multiple access (TDMA), frequency division multiple access (FDMA) and code division multiple access (CDMA). For FDMA, different carriers are used for different transmissions. For TDMA, a single carrier is divided into frames, and each frame is divided into a predetermined number of timeslots. For each transmission, one or more specific timeslots can then be employed in each frame. For CDMA, a spreading code is used for spreading user information bits by multiplying the user data with quasi-random bits, which are referred to as chips.

Universal Terrestrial Radio Access (UTRA) Time Division Duplex (TDD) uses a combined time division and code division multiple access scheme. Due to the TDMA part of the scheme, there are several possible timeslots for each transmitting direction on a single carrier. Due to the CDMA part of the scheme, in each slot one or more users, separated by orthogonal codes, can transmit or receive data simultaneously. One user can even occupy more than one timeslot in one direction during a multi-slot mode. UTRA TDD is specified for example in the 3rd Generation Partnership Project (3GPP) documents TS 25.221 V6.1.0 (2004-06): “Physical channels and mapping of transport channels onto physical channels (TDD)”, TS 25.222 V6.0.0. (2003-12): “Multiplexing and channel coding (TDD)”, TS 25.223 V6.0.0 (2003-12): “Spreading and modulation (TDD)”, TS 25.224 V6.1.0 (2004-06): “Physical layer procedures (TDD)” and TS 25.225 V6.1.0 (2004-03): “Measurements (TDD)”. A radio resource control protocol for the radio link between user equipment and an UTRAN (UTRA network) has been specified in the 3GPP document TS 25.331 V6.2.0 (2004-06): “Radio resource control”.

One UTRA TDD option is Time Division Synchronized CDMA (TD-SCDMA), which is also referred to as UTRA TDD 1.28 Mcps option. This particular option has been proposed by the China Wireless Telecommunication Standards group (CWTS) and is intended especially for a use in Chinese cellular communication systems.

During an inter-cell handover of user equipment between different cells of an UTRA TDD based cellular communication network, an admission control in the network has to determine which timeslot and code combinations are to be used by user equipment in the target cell for data transmission and reception.

The timeslot selection can be based for instance on minimizing the system costs in terms of a potential increase of transmission or reception power at a BTS, or on another evaluation methodology.

Typically, the admission control checks first for both directions, uplink and downlink, the code and power resources in the target cell and makes then a decision on the timeslot and code combinations which are to be used by the user equipment for transmission and for reception, respectively. Candidate timeslots are usually those timeslots which satisfy, according to the determined code and power resources, code and power conditions transmitted by the user equipment to the network in a Radio Access Bearer (RAB) resource request. A decision algorithm is then used by the admission control to select one of these candidate timeslots. The existing decision algorithms perform a random selection, a semi-static selection or a selection which results in the least power increase.

Regardless of the algorithm used, the timeslots which are assigned to the user equipment in the target cell might be different from the timeslots used in the source cell.

For example, if the user equipment uses for the uplink timeslot 1 in a source cell and timeslot 2 in a target cell of a handover, the handover implies removing an interference source in timeslot 1 from the neighborhood and adding an interference source in timeslot 2 to the neighborhood. The neighborhood includes all cells that can receive signals transmitted by the user equipment with a power exceeding a predetermined level. As a result, any user equipment in the neighborhood, which uses timeslot 1 or timeslot 2 for transmitting data, experiences a sudden change in the uplink interference.

In known approaches, this problem is dealt with by means of a power control. Controlling the level of employed transmission power in order to minimize interference and to maintain the quality of connections is described for example in the 3GPP document TS 25.401 V6.3.0 (2004-06): “UTRAN Overall Description”.

When given a sufficiently long time for a respective power adjustment, known power control algorithms are able to compensate changes in the interference by adjusting the power levels employed for the respective timeslots. But the time it takes the power control algorithm to converge may sometimes be considerable. Especially when some user equipment is moving on the border between two cells and therefore switching repeatedly between them, convergence might even not be reached at all.

A similar problem occurs in the downlink.

TD-SCDMA suffers particularly from sudden changes in the interferences, since it has a very low power control frequency. The power control frequency is once per sub-frame, which corresponds to 200 Hz. So it might take quite a while for the power control algorithm to converge.

It is to be understood, though, that the same problem may occur with other TDMA approaches as well.

### SUMMARY OF THE INVENTION

It is an object of the invention to reduce in a cellular communication system sudden changes in interference due to a handover of user equipment.

A method for supporting a handover of user equipment from a source cell of a cellular communication network to a target cell of the mobile communication network is proposed. The user equipment employs assigned timeslots for a data exchange with the cellular communication network while being associated to the source cell. The propose method comprises checking for at least one of the assigned timeslots whether it is suited to meet given conditions when employed in the target cell for a data exchange between user equipment and the cellular communication network. The proposed method further comprises assigning the at least one timeslot to the user equipment for use in a data exchange with the cellular communication network while the user equipment is associated to the target cell, in case the at least one timeslot is suited to meet the given conditions.

Moreover, a network element for a cellular communication network supporting a handover of user equipment from a source cell of the cellular communication network to a target cell of the mobile communication network is proposed. The user equipment is assumed to employ assigned timeslots for a data exchange with the cellular communication network while being associated to the source cell. The proposed network element comprises a handover control component, which is adapted to realize the steps of the proposed method. The network element can be, for example, a Radio Network Controller (RNC), while the handover control component can be, for example, a Radio Resource Management (RRM) including a handover control (HC).

Moreover, user equipment for a cellular communication system supporting its handover from a source cell of a cellular communication network to a target cell of the cellular communication network is proposed. The user equipment comprises a processing component (with associated memory) adapted to employ assigned timeslots for a data exchange with the cellular communication network while being associated to the source cell, and adapted to continue employing at least one of these timeslots for a data exchange with the cellular communication network while being associated to the target cell, in case the at least one timeslot is suited to meet given conditions when employed in the target cell for a data exchange between user equipment and the cellular communication network.

Moreover, a cellular communication system is proposed, which comprises at least the proposed network element. In addition it may comprise, for example, other elements of the cellular communication network and/or user equipment which is to be handed over.

Moreover, a software code for supporting a handover of user equipment from a source cell of a cellular communication network to a target cell of the mobile communication network is proposed. The user equipment is assumed to employ assigned timeslots for a data exchange with the cellular communication network while being associated to the source cell. When running in a network element of the cellular communication network, the software code realizing the steps of the proposed method. Finally, a software program product is proposed, which stores the proposed software code.

The invention proceeds from the idea that problems due to interference discontinuities can partially be resolved by reducing changes in the assignment of timeslots. It is therefore proposed that at least one timeslot assigned to user equipment is kept unchanged during an inter-cell handover of this user equipment whenever possible.

It is an advantage of the invention that it makes the radio frequency environment in a cellular communication system more continuous. If a timeslot can be kept during an inter-cell handover, the cells neighboring the source cell and the target cell will experience almost the same radio frequency environment during these timeslots as before the handover event. For the source cell from which the user equipment is handed over, the interference caused by the power transmitted in this timeslot changes from intra-cell interference to inter-cell interference.

For the target cell to which the user equipment is handed over, the interference caused by the power transmitted in this timeslot changes from inter-cell interference to intra-cell interference. In any case, the total power in this timeslot is not subject to a sudden change.

The invention provides particular benefits to systems using a low power control frequency, since here, a sudden change of interference is compensated slowly due to a slowly converging power control.

It is further an advantage of the invention that it is easy to implement.

The at least one assigned timeslot which is tried to be kept may, but does not have to, include all assigned timeslots.

For the downlink, a change of interference in neighboring cells due to a handover can usually not be alleviated considerably by allocating the same timeslot as before in the new cell, because the downlink interference source, usually the accessed BTS, and thus its location changes in the handover. One embodiment of the invention focuses therefore on the uplink. That is, the at least one timeslot which is kept, if possible, is an uplink timeslot assigned to the user equipment while being associated to the source cell. In this embodiment, thus the uplink radio frequency environment is made as continuous as possible.

In one embodiment, the given conditions are related to resources which are required to be available in the target cell for the at least one assigned timeslot.

In one embodiment of the invention, the at least one timeslot is assigned to the user equipment in the source cell in combination with at least one code for use in a data exchange with the cellular communication network. That is, the mobile communication network uses in this embodiment a combined time division and code division multiple access scheme, like UTRA TDD. The invention is particularly suited for such a combined TDMA/CDMA system, since a pure TDMA system is not interference limited in one timeslot.

In this case, the given conditions which are checked may comprise, for instance, code and power criteria provided by the user equipment.

The invention can be implemented in particular in a TD-SCDMA based system, in which the power control converges slowly. It can equally be used in various other TDMA based systems, though, for instance in a system supporting the UTRA TDD 3.84 Mcps option.

### BRIEF DESCRIPTION OF THE FIGURES

Other objects and features of the present invention will become apparent from the following detailed description considered in conjunction with the accompanying drawings.

FIG. 1 is a schematic block diagram of a cellular communication system in which the invention can be implemented; and

FIG. 2 is a flow chart illustrating an operation according to an embodiment of the invention in the system of FIG. 1.

### DETAILED DESCRIPTION OF THE INVENTION

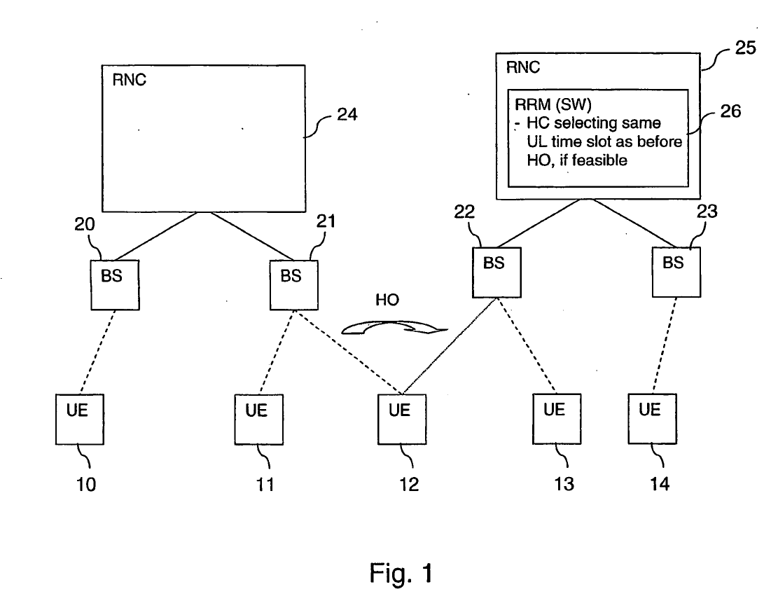

FIG. 1 is a schematic diagram of a cellular communication system, in which uplink timeslots are allocated to user equipment in accordance with the invention.

The cellular communication system can be by way of example a TD-SCDMA system, which comprises user equipment (UE) 10, 11, 12, 13, 14 and a cellular communication network.

The cellular communication network includes a plurality of base stations (BS) 20, 21, 22, 23, each serving a different cell area. Each base station 20, 21, 22, 23 is connected to an RNC 24, 25 of the cellular communication network. In FIG. 1, base stations 20 and 21 are connected to RNC 24, while base stations 22 and 23 are connected to RNC 25. It is to be understood that alternatively, at least one of the base stations could comprise a plurality of distributed BTSs, each serving a different cell area.

Each RNC 24, 25 comprises an RRM 26 implemented in software, which can be executed by a processing component of the RNC 24, 25. The software comprises an HC portion, which is responsible for assigning radio resources to user equipment in the scope of a handover.

User equipment 10 is currently accessing the cellular communication network via base station 20. User equipment 11 and 12 is currently accessing the cellular communication network via base station 21. User equipment 13 is currently accessing the cellular communication network via base station 22. User equipment 14 is currently accessing the cellular communication network via base station 23.

In the following, a handover of user equipment 12 from base station 21 to base station 22 will be considered.

While accessing the cellular communication network via base station 21, one or more combinations of a particular timeslot and a particular code are assigned to user equipment 12 for the uplink and one or more combinations of a particular timeslot and a particular code are assigned to user equipment 12 for the downlink.

While accessing the cellular communication network via base station 21, user equipment 12 via a processing component (and associated memory) performs measurements on signals from neighboring base stations 20, 22, 23 in order to determine whether the cell served by the base station 21 is still appropriate or whether a handover to another cell would be better, for instance in view of the signal strength of monitored signals. When user equipment 12 detects that a handover to the cell served by base station 22 would be better suited for accessing the cellular communication network than the cell served by base station 21, the user equipment 12 transmits a RAB resource request via base station 22 to RNC 25. The required traffic QoS is mapped to an attribute in the RAB. In RNC 25, the request is taken care of by the RRM 26. In this handover, the cell served by base station 21 is thus a source cell, while the cell served by base station 22 is a target cell.

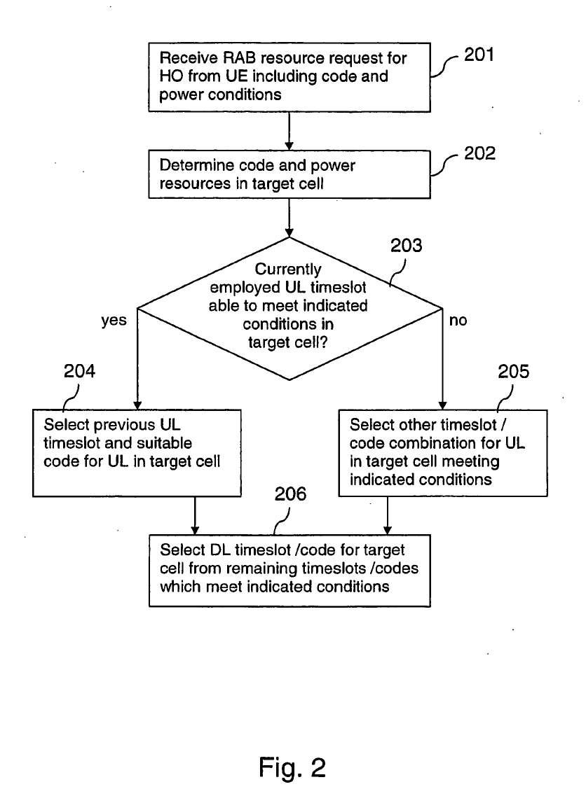

The subsequent operation in RNC 25 in accordance with an embodiment of the invention will now be described with reference to FIG. 2. FIG. 2 is a flow chart which illustrates specifically a process realized by the HC portion of the RRM 26 of RNC 25.

First, the RRM 26 receives the RAB resource request for a handover from the user equipment 12 (step 201). Due to the mapped QoS, the RAB resource request indicates code and power conditions which should be met by the timeslot and code combinations that are to be assigned to user equipment 12 for the target cell.

The RRM 26 determines thereupon the code and power resources in the target cell in a conventional manner (step 202).

Based on the determined code and power resources, the RRM 26 checks next whether the indicated code and power conditions can also be met in the target cell specifically with the at least one uplink timeslot currently employed by user equipment 12 in the source cell in combination with at least one code which is available for this at least one time slot (step 203).

If the conditions can be met, the RRM 26 assigns the currently employed at least one uplink timeslot to the user equipment 12 as well for the target cell. In addition, at least one available code is selected with which the indicated conditions can be met in this at least one timeslot. (step 204)

As a result, the neighboring cells served by base stations 20 and 23 experience almost the same radio frequency interferences as before. The influence on the link between user equipment 10 and base station 20 as well as on the link between user equipment 14 and base station 23 thus stays basically the same. For the source cell, the power transmitted by user equipment 12 changes from causing intra-cell interference to causing inter-cell interference within the same timeslots. The influence on the link between user equipment 11 and base station 21 thus stays basically the same as well. For the target cell, the power transmitted by user equipment 12 changes from causing inter-cell interference to causing intra-cell interference. The influence on the link between user equipment 13 and base station 22 thus stays equally basically the same as well.

Only in case the indicated conditions cannot be met when assigning the same uplink timeslot or timeslots as before to user equipment 12, the RRM 26 selects and assigns at least one new uplink timeslot and code combination to user equipment 12 for the target cell. The selection is made from all available timeslot and code combinations meeting the indicated conditions, where the available combinations are known from step 202. The selection can be for instance random, semi-static or depend on the least power increase, as known from conventional decision algorithms. (step 205)

In this case, the change in interference is the same as in a conventional handover.

Finally, the RRM 26 selects and assigns at least one downlink timeslot and code combination to user equipment 12 for the target cell. The selection can be made from all remaining available timeslot and code combinations meeting the indicated conditions, where the available combinations are known from step 202. The selection can be again for instance random, semi-static or depend on the least power increase, as known from conventional decision algorithms. (step 206)

The change in interference is the same as in a conventional handover.

It is to be noted that the described embodiment can be varied in many ways and that it moreover constitutes only one of a variety of possible embodiments of the invention.

1. Method for supporting a handover of user equipment (12) from a source cell of a cellular communication network to a target cell of said mobile communication network, wherein said user equipment (12) employs assigned timeslots for a data exchange with said cellular communication network while being associated to said source cell, said method. comprises:
checking for at least one of said assigned timeslots whether it is suited to meet given conditions when employed in said target cell for a data exchange between user equipment and said cellular communication network (step 203); and
in case said at least one timeslot is suited to meet said given conditions, assigning said at least one timeslot to said user equipment (12) for use in a data exchange with said cellular communication network while said user equipment (12) is associated to said target cell (step 204).

2. Method according to claim 1, wherein said at least one timeslot comprises at least one uplink timeslot employed by said user equipment (12) while being associated to said source cell.

3. Method according to claim 1, wherein said given conditions are related to resources which are required to be available in said target cell for said at least one assigned timeslot.

4. Method according to claim 1, wherein said at least one timeslot is assigned to said user equipment in said source cell in combination with at least one code for use in a data exchange with said cellular communication network.

5. Method according to claim 4, wherein said given conditions are code and power conditions provided by said user equipment (12).

6. Method according to claim 4, wherein said cellular communication network is a Time-Division-Synchronized Code-Division-Multiple-Access based mobile communication network.

7. Network element (25) for a cellular communication network supporting a handover of user equipment (12) from a source cell of said cellular communication network to a target cell of said mobile communication network, wherein said user equipment (12) employs assigned timeslots for a data exchange with said cellular communication network while being associated to said source cell, said network element (25) comprising a handover control component (26),
which handover control component (26) is adapted to check for at least one of said assigned timeslots whether it is suited to meet given conditions when employed in said target cell for a data exchange between user equipment and said Cellular communication network; and
which handover control component (26) is adapted to assign said at least one timeslot to said user equipment (12) for use in a data exchange with said cellular communication network while said user equipment (12) is associated to said target cell, in case said at least one timeslot is suited to meet said given conditions.

8. Network element (25) according to claim 7, wherein said network element (25) is a Radio Network Controller.

9. Network element (25) according to claim 7, wherein said handover control component (26) is a Radio Resource Management including a handover control portion.

10. User equipment (12) for a cellular communication system supporting its handover from a source cell of a cellular communication network to a target cell of said cellular communication network, wherein said user equipment (12) comprises means adapted to employ assigned timeslots for a data exchange with said cellular communication network while being associated to said source cell, and adapted to continue employing at least one of said timeslots for a data exchange with said cellular communication network while being associated to said target cell, in case said at least one timeslot is suited to meet given conditions when employed in said target cell for a data exchange between user equipment and said cellular communication network.

11. Cellular communication system comprising at least one network element (25) according to claim 7.

12. Cellular communication system according to claim 11, further comprising user equipment (12).

13. Software code for supporting a handover of user equipment (12) from a source cell of a cellular communication network to a target cell of said mobile communication network, wherein said user equipment (12) employs assigned timeslots for a data exchange with said cellular communication network while being associated to said source cell, said software code realizing the following step when running in a network element (25) of said cellular communication network:
checking for at least one of said assigned timeslots whether it is suited to meet given conditions when employed in said target cell for a data exchange between user equipment and said cellular communication network (step 203); and
in case said at least one timeslot is suited to meet said given conditions, assigning said at least one timeslot to said user equipment (12) for use in a data exchange with said cellular communication network while said user equipment (12) is associated to said target cell (step 204).

14. Software program product storing a software code according to claim 13.
